(19) United States
(12) Patent Application Publication
(10) Pub. No.: US 2001/0035853 A1
(43) Pub. Date: Nov. 1, 2001

(54) Assembly of a display device and an illumination system

(75) Inventors: Christoph Gerard August Hoelen, Eindhoven (NL); Gerard Harbers, Best (NL)

Correspondence Address: Corporate Patent Counsel, U.S. Philips Corporation, 580 White Plains Road, Tarrytown, NY, 10591, US

(73) Assignee: U.S. PHILIPS CORPORATION

(21) Appl. No.: 09/837,937

(22) Filed: Apr. 19, 2001

(30) Foreign Application Priority Data
Apr. 4, 2000 (EP) 00201603.8

(51) Int. Cl. G09G 3/36

(52) U.S. Cl. 345/102

(57) ABSTRACT

The system comprises a display device with a pattern of pixels (3) controlled by a control circuit (8) and a backlight system for illuminating the display device, which backlight system comprises a light-emitting panel and a light source (16, 16′, 16″, . . . ) associated with the light-emitting panel. The light source comprises a plurality of light-emitting diodes (LEDs) of at least two different colors. The control circuit (8) also controls the luminous flux of the LEDs. Preferably, the intensity of the light emitted by the LEDs (16, 16′, 16″) varies with the light level of the image to be displayed by the display device. Preferably, the intensity of the light emitted by the backlight system can be controlled on a frame-to-frame basis and, preferably, also for each color. Preferably, the LEDs comprise a plurality of red, green, blue (and amber) LEDs, each, preferably, having a luminous flux of at least 5 lumen. The color point of an image to be displayed on the display screen of the display device is set by the backlight system, enabling an optimum contrast to be obtained for the image to be displayed by the display device.

The invention relates to an assembly comprising

a display device provided with a pattern of pixels driven by a control circuit,

and an illumination system for illuminating the display device,

said illumination system comprising a light-emitting panel and at least one light source, said light source being associated with the light-emitting panel.

The invention further relates to a display device for use in said assembly.

The invention also relates to an illumination system for use in said assembly.

Such assemblies are known per se. They are used, inter alia, in television receivers and monitors. Such assemblies are particularly applied in non-emissive displays, such as liquid crystal display devices, also referred to as LCD panels, in combination with so-called backlights, for example edge lighting illumination systems. Such illumination systems are used, in particular, in display screens of (portable) computers or in datagraphic displays, for example (cordless) telephones, in navigation systems, in vehicles or in (process) control rooms.

In general, a display device mentioned in the opening paragraph comprises a substrate provided with a regular pattern of pixels, which are each driven by at least one electrode. In order to form an image or a datagraphic representation in a relevant area of a (display) screen of the (picture) display device, the display device employs a control circuit. In an LCD device, the light originating from the backlight is modulated by means of a switch or a modulator, and use is made of various types of liquid crystal effects. Besides, the display may be based on electrophoretic or electromechanical effects.

In the illumination system mentioned in the opening paragraph, the light source used generally is a tubular low-pressure mercury vapor discharge lamp, for example one or more compact fluorescent lamps, wherein the light emitted, in operation, by the light source is coupled into the light-emitting panel, which functions as an optical waveguide. This optical waveguide generally forms a comparatively thin and flat panel which is made, for example, of a synthetic resin or glass, light being transported through said optical waveguide under the influence of (total) internal reflection.

Such an illumination system may alternatively be provided with a light source in the form of a plurality of optoelectronic elements, also referred to as electro-optical elements, for example electroluminescent elements, such as light-emitting diodes (LEDs). These light sources are generally provided in the proximity of, or in contact with, a light-transmitting (edge) area of the light-emitting panel, so that, in operation, light originating from the light source is incident on the light-transmitting (edge) area and diffuses in the panel.

EP-A 915 363 discloses an assembly of an LCD display device and an illumination system, wherein the illumination system comprises two or more light sources for generating light of different color temperatures. In this manner, the LCD display device is illuminated in accordance with the desired color temperature. For the light source use is made of different types of fluorescent lamps which, in operation, emit light of different, comparatively high color temperatures.

An assembly of the above-mentioned type has the disadvantage that the light sources in the illumination system of the known assembly have a fixed color temperature, so that the color point of an image to be displayed by the display device can only be adjusted by mutually controlling the transmission factors of the pixels of the display device. This leads to a reduction of the contrast of the display device.

It is an object of the invention to completely or partly overcome said drawback. The invention more particularly aims at providing an assembly of the type mentioned in the opening paragraph, wherein the contrast of the display device is improved.

In accordance with the invention this object is achieved in that

the light source comprises at least two light-emitting diodes having different light-emission wavelengths, and in that

the control circuit also drives the luminous fluxes of the light-emitting diodes in dependence upon an image to be displayed by the display device.

By applying LEDs having different light-emission wavelengths and controlling the relative intensities of the LEDs of different colors, the color point of an image to be displayed by the display device can be adjusted without controlling the transmission factors of the pixels of the display device. In other words, changing the color point of an image displayed by the display device is controlled by the illumination system, not by the display device. If a substantial contribution of the display device is required to control the color point of the image to be displayed, then the contrast of the image displayed is reduced.

The inventors have recognized that by suitably unlinking the functions of the illumination system and the display device in the assembly, an increase of the contrast of the image displayed by the display device is achieved. If the color point of the image displayed by the display device is controlled mainly by the illumination system, then the transmission factors of the pixels of the display device can be optimally used to display a high-contrast image.

In accordance with the invention, the luminous fluxes of the LEDs are controlled by the control circuit. It is particularly suitable if this control circuit can be influenced by the user of the assembly, through a sensor which, for example, measures the color temperature of the ambient light, through a video card of, for example, a (personal) computer and/or through drive software of a computer program.

The amount of light emitted by the LEDs is adjusted by varying the luminous fluxes of the relevant light-emitting diodes. This luminous flux control operation generally takes place in a very energy-efficient manner. For example, LEDs can be dimmed without an appreciable loss of light output.

A preferred embodiment of the assembly in accordance with the invention is characterized in that the control circuit varies the intensities of the light emitted by the light-emitting diodes in response to the illumination level of the image to be displayed by the display device.

If, by way of example, the illumination level of an image to be displayed by the display device is comparatively low, for example in the case of a scene in nocturnal conditions in a video film, the control circuit in accordance with the invention instructs the illumination system to effect a corresponding reduction of the light output of the LEDs. In that case, the illumination system couples out a comparatively small amount of light for illuminating the display device. The pixels of the display device do not have to be “pinched” to reduce the light from the illumination system. The transmission of the pixels of the display device can thus be optimally used to display a high-contrast image. In this manner a high-contrast image can be obtained, in spite of a comparatively low illumination level of the image to be displayed by the display device.

When an image having a comparatively low illumination level is displayed, in the known assembly, the transmission of the pixels is reduced in order to obtain the desired low light level. This leads to a low-contrast image, which is unfavorable and undesirable.

If low-pressure mercury-vapor discharge lamps are used as the light source in an illumination system, these discharge lamps can be dimmed, however, it takes comparatively much time and it is not energy-efficient.

By unlinking the illumination function and the display function of the display device, the illumination function being left to the illumination system, an assembly in accordance with the invention having dynamic contrast possibilities is obtained. The assembly in accordance with the invention results in an intelligent backlight, as it were, for illuminating the (image) display device in dependence upon the image to be displayed by the display device.

A particularly favorable embodiment of the assembly in accordance with the invention is characterized in that the intensities of the light emitted by the light-emitting diodes can be adjusted on a frame-to-frame basis. The luminous fluxes of the LEDs can be adjusted sufficiently rapidly to supply the desired light intensity from frame to frame. LEDs can be dimmed without an appreciable loss of light output.

An alternative, favorable embodiment of the assembly in accordance with the invention is characterized in that the intensities of the light emitted by the light-emitting diodes can be adjusted for each color on a frame-to-frame basis. The luminous flux of each of the LEDs of a different color can be adjusted sufficiently rapidly to supply the desired light intensities from frame to frame. An advantage of the adjustability of the LEDs for each color resides in that a (set of) video frames can be provided with a “punch” or “boost” of a certain color. This means that the light intensity of one type of the colored LEDs is temporarily operated in the “overdrive” mode. The luminous flux through the other types of colored LEDs can be simultaneously reduced, or even switched off, at will.

Preferably, the light source comprises at least three light-emitting diodes having different light-emission wavelengths. Particularly suitable is a combination of red, green and blue LEDs, which is known per se. In an alternative embodiment, the light source comprises four LEDs of different colors, i.e. a combination of red, green, blue and amber LEDs. Combinations of said three or more LEDs of different colors enable large areas to be encompassed in the 1931 C.I.E. color triangle known to those skilled in the art. A suitable choice of the color co-ordinates of the LEDs and of the ratio between the various colors enables the illumination system to generate light having a great variety of color temperatures and color points. For example, given the desired color temperature of the light coupled out by the light-emitting panel, the color point of the light can be chosen to be on the black body locus. A color point on the black body locus is alternatively referred to as the “white point” (at the given color temperature).

Preferably, each of the light-emitting diodes has a luminous flux of at least 5 lm. LEDs having such a high output are alternatively referred to as LED power packages. The application of these high-efficiency, high-output LEDs has the specific advantage that the number of LEDs can be comparatively small at a desired, comparatively high light output. This has a favorable effect on the compactness and the efficiency of the illumination system to be manufactured. Further advantages of the use of LEDs are: a comparatively very long service life, comparatively low energy costs and comparatively low maintenance costs of an illumination system comprising LEDs. The use of LEDs yields dynamic illumination possibilities.

These and other aspects of the invention will be apparent from and elucidated with reference to the embodiment(s) described hereinafter.

In the drawings:

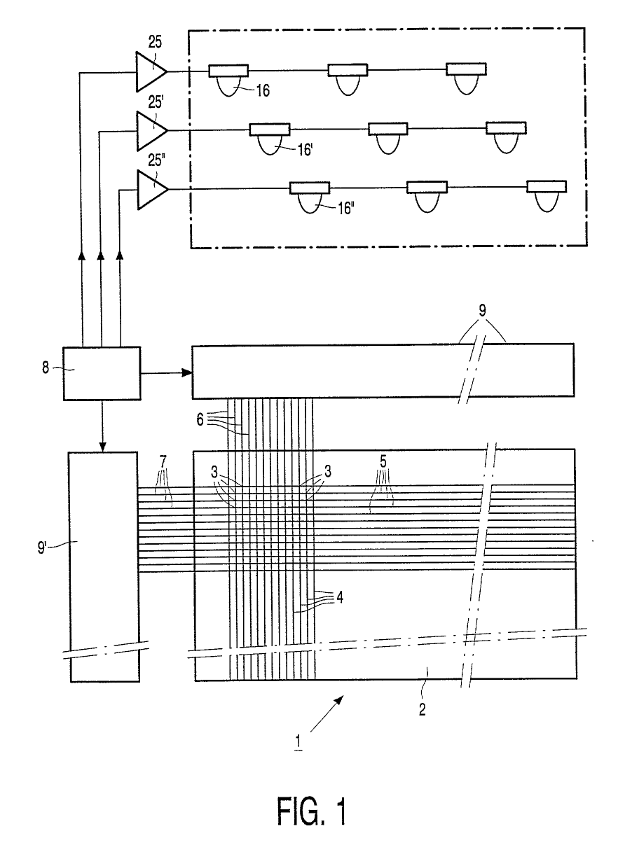

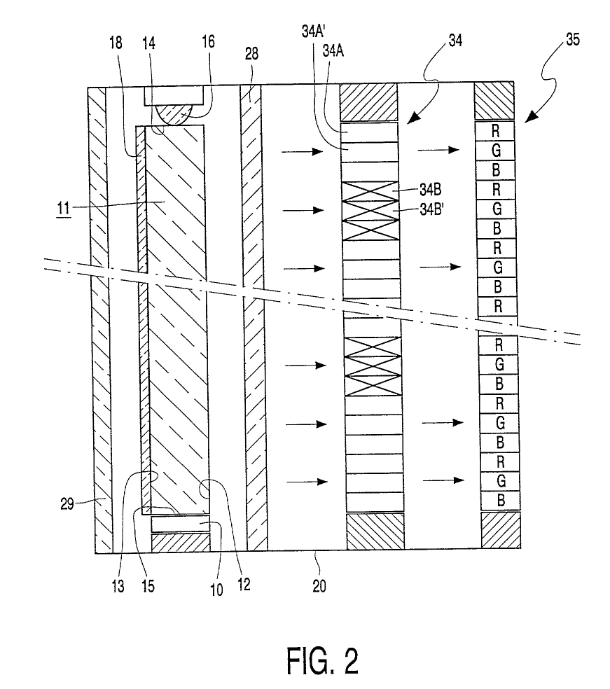

FIG. 1 diagrammatically shows a block diagram of an assembly comprising a display device and an illumination system in accordance with the invention;

FIG. 2 is a cross-sectional view of an embodiment of the assembly in accordance with the invention;

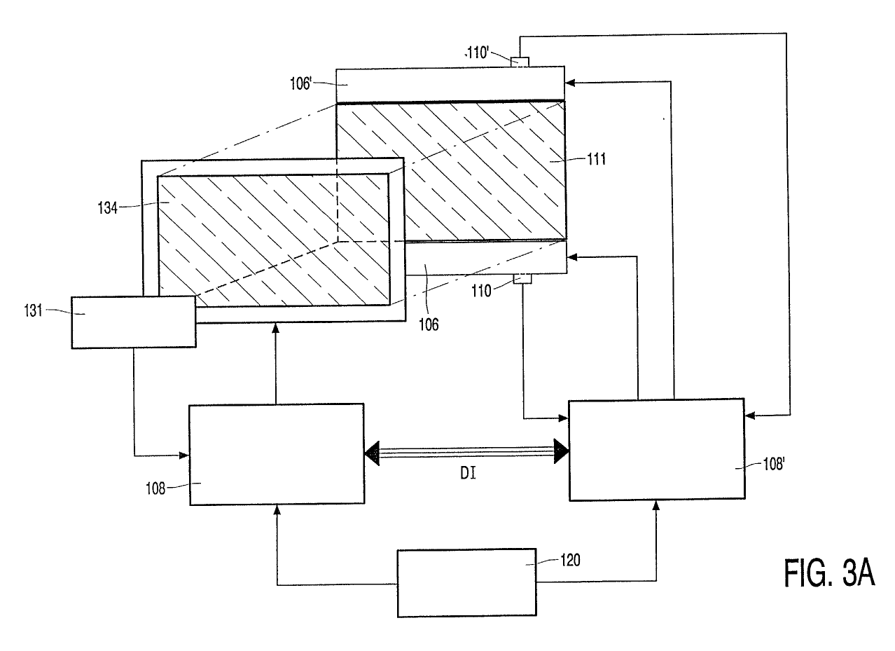

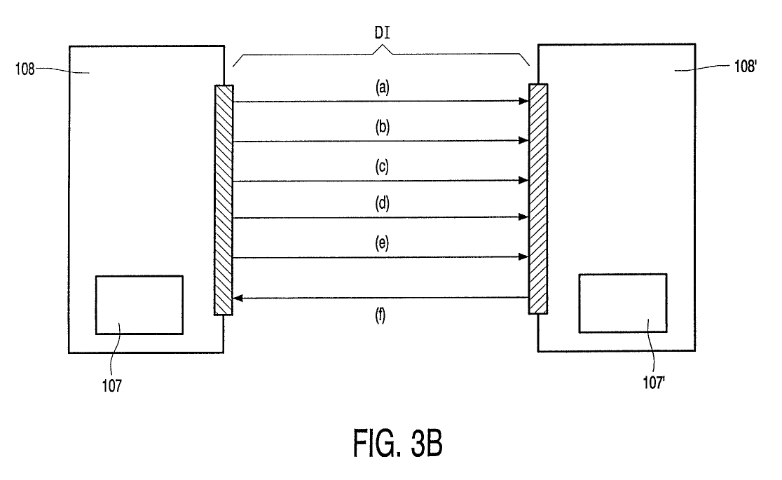

FIG. 3A diagrammatically shows a block diagram of an assembly comprising a display device and an illumination system in accordance with the invention, and

FIG. 3B diagrammatically shows a block diagram of a driver interface between the display device and the illumination system.

The drawings are purely diagrammatic and not drawn to scale. Particularly for clarity, some dimensions are exaggerated strongly. In the Figures, like-reference numerals refer to like-parts whenever possible.

FIG. 1 very diagrammatically shows a block diagram of an assembly comprising a display device and an illumination system in accordance with the invention. The (picture) display device comprises a substrate 1 having a surface 2 provided with a pattern of pixels 3, which are mutually separated (the distance between them being predetermined) in the vertical and the horizontal direction. Each pixel 3 is activated, during selection via a switching element, by means of an electrode 5 of a first group of electrodes, the voltage at a data electrode (electrode 4 of a second group of electrodes) determining the picture content. The electrodes 5 of the first group of electrodes are alternatively referred to as column electrodes, and the electrodes 4 of the second group of electrodes are alternatively referred to as row electrodes.

In a so-called actively driven display device, electrodes 4 receive (analog) control signals via parallel conductors 6 from a control circuit 9, and electrodes 5 receive (analog) control signals via parallel conductors 7 from a control circuit 9′. In an alternative embodiment of the display device, the electrodes are driven via a so-called passive drive.

To form a picture or a datagraphic representation in a relevant area of the surface 2 of the substrate 1 of the display device, the display device employs a control circuit 8, which drives the control circuits 9, 9′. In the display device, various types of electro-optical materials may be used. Examples of electro-optical materials are (twisted) nematic or ferroelectric liquid crystal materials. In general, the electro-optical materials attenuate the passed or reflected light in dependence upon a voltage applied across the material.

The illumination system which is very diagrammatically shown in FIG. 1 comprises a plurality of light-emitting diodes (LEDs) 16, 16′, 16″, . . . having different light-emission wavelengths. The LEDs 16, 16′, 16″, . . . are driven by the control circuit 8 via amplifiers 25, 25′; 25″. In accordance with the measure of the invention, the control circuit 8 drives the display device and the luminous fluxes of the LEDs in dependence upon an image to be displayed by the display device. In the example shown in FIG. 1, reference numeral 16 corresponds to a plurality of red LEDs, reference numeral 16′ corresponds to a plurality of green LEDs, and reference numeral 16″ corresponds to a plurality of blue LEDs. Preferably, the LEDs are arranged in a (linear) array of alternately red, green and blue LEDs. In the example shown in FIG. 1, the control circuit 8 drives the LEDs 16, 16″, 16″ on a color-to-color basis. In an alternative embodiment, the control circuit drives each one of the LEDs individually. An advantage of individually driving each one of the LEDs is that, for example in the case of failure of one of the LEDs, appropriate measures can be taken in the illumination system to compensate for the effect of this failure, for example by increasing the luminous fluxes of nearby LEDs of a corresponding color.

The source brightness of LEDs is many times that of fluorescent tubes. In addition, when use is made of LEDs, the efficiency with which light is coupled into the panel is higher than in the case of fluorescent tubes. The use of LEDs as the light source has the advantage that the LEDs may be in contact with panels made of a synthetic resin. LEDs hardly emit heat in the direction of the light-emitting panel 11, nor do they emit detrimental (UV) radiation. The use of LEDs has the additional advantage that means for coupling light originating from the LEDs into the panel are not necessary. The use of LEDs leads to a more compact illumination system.

The LEDs 16, 16′, 16″ are preferably LEDs having a luminous flux above 5 lm. LEDs having such a high output are alternatively referred to as LED power packages. Examples of power LEDs are “Barracuda”-type LEDs (Lumileds). The luminous flux per LED is 15 lm for red LEDs, 13 lm for green LEDs, 5 lm for blue LEDs and 20 lm for amber LEDs. In an alternative embodiment, “Prometheus”-type LEDs (Lumileds) are used, the luminous flux per LED being 35 lm for red LEDs, 20 lm for green LEDs, 8 lm for blue LEDs and 40 lm for amber LEDs.

Preferably, the LEDs 16, 16′, 16″ are mounted on a (metal-core) printed circuit board. If power LEDs are provided on such a (metal-core) printed circuit board (PCB), the heat generated by the LEDs can be readily dissipated by means of heat conduction via the PCB. In an interesting embodiment of the illumination system, the (metal-core) printed circuit board is in contact with the housing of the display device via a heat-conducting connection.

FIG. 2 is a diagrammatic, cross-sectional view of an embodiment of the assembly in accordance with the invention. The illumination system comprises a light-emitting panel 11 of a light-transmitting material, which is made from, for example, a synthetic resin, acryl, polycarbonate, PMMA, such as Perspex, or glass. Under the influence of total internal reflection, light is transported, in operation, through the panel 11. The panel 11 has a front wall 12 and a rear wall 13 opposite said front wall. Between the front wall 12 and the rear wall 13, there are edge areas 14, 15. In the example shown in FIG. 2, the edge area referenced 14 is light-transmitting, a plurality of LEDs 16 of different colors (only one LED being shown in FIG. 2) being associated therewith.

In accordance with the invention, the LEDs 16 are driven by the control circuit 8 (not shown in FIG. 2). In operation, light originating from the LEDs 16 is incident on the light-transmitting edge area 14 and diffuses into the panel 11. In accordance with the principle of total internal reflection, the light keeps going back and forth in the panel 11, unless the light is coupled out of the panel 11, for example, by a deliberately provided deformity. The edge area opposite the light-transmitting edge area 14 is referenced 15 and is provided, except at the location where a sensor 10 is situated for measuring the optical properties of the light emitted in operation by the LEDs, with a reflecting coating (not shown in FIG. 2) for keeping the light originating from the light source 16, 16′, 16″ inside the panel. Said sensor 10 is coupled to the control circuit 8 (not shown in FIG. 2) for suitably adapting and/or changing the luminous fluxes through the LEDs 16, 16′, 16″. By means of the sensor 10 and the control circuit 8, a feedback mechanism can be formed for influencing the quality and the quantity of the light coupled out of the panel 11.

Coupling means for coupling out light are provided on a surface 18 of the rear wall 13 of the light-emitting panel 11. These coupling means serve as a secondary light source. A specific optical system may be associated with this secondary light source, which optical system is provided, for example, on the front wall 12 (not shown in FIG. 2). The optical system may be used, for example, to form a broad light beam.

Said coupling means consist of (patterns of) deformities and comprise, for example, screen-printed dots, wedges and/or ridges. The coupling means are formed in the rear wall 13 of the panel 11, for example, by means of etching, scribing or sandblasting. In an alternative embodiment, the deformities are formed in the front wall 12 of the panel 11. The light is coupled out of the illumination system in the direction of the LCD display device (see the horizontal arrows in FIG. 2) by means of reflection, scattering and/or refraction.

FIG. 2 shows an optional (polarizing) diffuser 28 and a reflective diffuser 29, which bring about further mixing of the light originating from the light-emitting panel 11, and which make sure that the light has the desired direction of polarization for the (LCD) (picture) display device.

FIG. 2 also very diagrammatically shows an example of an LCD display device comprising a liquid crystal display (LCD) panel 34 and a color filter 35. In FIG. 2, LC elements 34A, 34A′ are connected so as to allow passage of light. LC elements 34B, 34B′ (marked with a cross), however, do not allow passage of light (see the horizontal arrows in FIG. 2). In this example, the color filter 35 comprises three basic colors denoted by R (red), G (green) and B (blue). The R, G, B filter elements in the color filter 35 correspond to the LC elements of the LCD panel 34. The R, G, B filter elements only pass light that corresponds to the color of the filter element.

The illumination system assembly comprising the light-emitting panel 11, the LEDs 16 and the display device comprising the LCD panel 34 and the color filter 35 in a housing 20 is used, in particular, to display (video) images or datagraphic information.

In the known assembly, a white point is formed on the display device by leading white light originating from fluorescent lamps having a fixed color temperature via the LC elements to the corresponding R, G, B filter elements. This is brought about by controlling the three LC elements so as to be in the position where they allow passage of light If a desired color temperature of the image to be displayed by the display device differs from the color temperature corresponding to the light emitted by the fluorescent lamps, then the transmission factors of three LC elements are controlled such that the desired shift of the color temperature is achieved. To achieve this, generally a substantial part of the light passed by the LC elements must be stopped because, in order to change the color temperature, a substantial part of the blue or red light in the visible spectrum must be captured. Since the LC elements stop a substantial part of the light, a considerable reduction in contrast of the image to be displayed takes place.

By way of example, Table I lists the lumen fractions necessary to generate white light at a color temperature of 6500 K and 9500 K without changing the luminous flux through the LEDs for a combination of three LEDs, i.e. a red LED with a spectral emission maximum at 610 nm, a green LED with a spectral emission maximum at 533 nm, and a blue LED with a spectral emission maximum at 465 nm.

TABLE I
Lumen fractions at different color temperatures

| | lumen fraction at | lumen fraction at | change in lumen |
|---|---|---|---|
| | 6500 K | 9500 K | output (%) |
| red | 26.4% | 23.8% | −9.8% |
| green | 65.1% | 64.8% | −0.5% |
| blue | 8.6% | 11.4% | +32.6% |

Table I shows that in order to make white light at a color temperature of 6500 K as well as at a color temperature of 9500 K without the luminous fluxes of the LEDs being controlled, the transmission factors of the LC elements at 6500 K must be 100% for red, 100% for green and 75.4% for blue, and the transmission factors of the LC elements at 9500 K must be 90% for red, 99.5% for green and 100% for blue. Consequently, if the display device must bring about changes in color temperature, this will result in a considerable reduction in contrast of the image displayed by the display device.

In the assembly in accordance with the invention, the change of the color temperature is unlinked from (the LC elements in) the display device and delegated to the illumination system. If a different color of the image to be displayed by the display device is desired, then the differently colored LEDs are driven in the illumination system by the control circuit in such a manner that the color temperature of the light emitted by the illumination system is adapted to the desired color point of the image to be displayed by the display device.

The luminous fluxes through the LEDs can be controlled in an energy-efficient manner. In addition, the intensities of the light to be emitted by the differently colored LEDs can be controlled so rapidly that the color temperature of the light to be displayed by the illumination system can be adjusted on the display device for each image. If the display device is an LCD panel, the adaptation of the luminous fluxes through the LEDs can generally take place at a lower frequency than the frame-to-frame shifting in the display device. This can be attributed to the fact that in order to control an LC element so as to change from (completely) open to (completely) closed, a plurality of steps are necessary in the LCD panel. The control circuit adapts the transmittance of the relevant LC element on a frame-to-frame basis.

In accordance with the measure according to the invention, the LC elements do not have to contribute any more to the color temperature of the image to be displayed by the display device. As a result, the LC elements can be very effectively used to display a high-contrast image. Consequently, the desired mixed colors of red, green and blue can be formed on the display device by guiding light originating from the illumination system via the LC elements to the corresponding R, G, B filter elements, the transmittance of each one of the LC elements corresponding to the desired color. In this situation, additional pinching of the LC elements to simultaneously bring about the desired color temperature of the image to be displayed by the display device is not necessary.

In accordance with the invention, the luminous fluxes of the LEDs are controlled by the control circuit. It is particularly suitable if this control circuit can be influenced by the user of the assembly, through a sensor which measures the color temperature of the ambient light, through a video card of, for example, a (personal) computer and/or through drive software of a computer program. For an assembly comprising a display device for displaying datagraphic information, the use of two LEDs having different light-emission wavelengths in the illumination system is generally sufficient. A combination of red and cyan/blue LEDs is very suitable. If, for example, red LEDs having a spectral emission maximum at 610 nm are combined with cyan/blue LEDs having a spectral emission maximum at 491 nm, then a white point at 6500 K is obtained by applying a lumen fraction of red of 37.7% and a cyan/blue lumen fraction of 62.3%. In an alternative embodiment, red LEDs having a spectral emission maximum at 610 nm are combined with cyan LEDs having a spectral emission maximum at 497 nm, resulting in a white point at 4000 K being obtained by applying an amber lumen fraction of 32.67% and a cyan lumen fraction of 57.4%. Other suitable combinations of two types of LEDs are amber and cyan/blue. If, for example, amber LEDs having a spectral emission maximum at 591 nm are combined with cyan/blue LEDs having a spectral emission maximum at 488 nm, then a white point at 6500 K is obtained by applying an amber lumen fraction of 50.7% and a cyan/blue lumen fraction of 49.3%. In such applications, light sources emitting yellow or blue light are generally not used for reasons relating to contrast. In such illumination systems, generally a so-called two-pixel LCD display device is used, which comprises only two different color filters. Such display devices have a higher resolution and a higher brightness.

In an assembly comprising a display device for playing, for example, a video film, use is made of an illumination system comprising the same three basic colors as in the display device, namely red, green and blue. In an alternative embodiment, the illumination system comprises LEDs of four different colors, namely red, green, blue and amber.

FIG. 3A diagrammatically shows a block diagram of an assembly comprising a display device and an illumination system in accordance with the invention. The display device 134 is, in this example, a so-called TFT color LCD module. The display device 134 is provided with monitor controls 131, inter alia, for enabling the user to control the brightness, the contrast and the colors of the image to be displayed by the display device. The display device 134 is driven by a control circuit, in this example an LCD driver 108, which is influenced by the settings of the monitor controls 131. The LCD driver 108 receives its instructions from a video processor (not shown in FIG. 3A).

The illumination system comprises a light-emitting panel 111, wherein two modules 106, 106′ are provided with a plurality of LEDs. For the sake of clarity, the light-emitting panel 111 is drawn separately from and shifted with respect to the display device 134. Each one of the modules 106, 106′ is provided with a sensor 110, 110′ for measuring the optical properties of the light which, in operation, is emitted by the LEDs. The modules 106, 106′ are driven by the LED driver 108′, which also receives the signals originating from the sensors 110, 110′. In operation, a power supply 120 provides the assembly with electric power. In accordance with the invention, a so-called driver interface DI, which is responsible for the communication between the (picture) display device and the illumination system, is situated between the LCD driver 108 and the LED driver 108′.

FIG. 3B diagrammatically shows a block diagram of the driver interface DI between the display device and the illumination system (detail of FIG. 3A). The driver interface DI transports a number of signals, for example a synchronization signal (a) and information about the desired light levels of the various colors, for example of the red (b), green (c) and blue (d) light. The LCD driver 108 may additionally, or instead of the information about the desired light levels of the various colors, send the desired color point (e) to the LED driver 108′ via the driver interface DI. Also the LED driver 108′ can send a signal (7) to the LCD driver 108 via the driver interface DI, for example information about the maximally permissible values of the luminous fluxes through the LEDs. This may be important in the situation wherein a “punch” or “boost” of a certain color is brought about on the display device 134 by the LCD driver 108 for a certain period of time. The LED driver 108′ is capable of feeding back information as to which luminous flux is still permissible for the relevant LED or LEDs, thereby precluding that the temperature of the relevant LED or LEDs becomes too high. In the example shown in FIG. 3B, both the LCD driver 108 and the LED driver 108′ also comprise a controller 107, 107′, respectively, for processing the signals.

It will be clear that, within the scope of the invention, many variations are possible to those skilled in the art.

The scope of protection of the invention is not limited to the examples given hereinabove. The invention is embodied in each novel characteristic and each combination of characteristics. Reference numerals in the claims do not limit the scope of protection thereof. The use of the verb “to comprise” and its conjugations does not exclude the presence of elements other than those mentioned in the claims. The use of the article “a” or “an” in front of an element does not exclude the presence of a plurality of such elements.

1. An assembly comprising
a display device provided with a pattern of pixels (3) driven by a control circuit (8),
and an illumination system for illuminating the display device,
said illumination system comprising a light-emitting panel (11) and at least one light source (16, 16′, 16″, . . . ), said light source (16, 16′, 16″, . . . ) being associated with the light-emitting panel (11), characterized in that
the light source comprises at least two light-emitting diodes (16, 16′, 16″, . . . ) having different light-emission wavelengths, and
the control circuit (8) also drives the luminous fluxes of the light-emitting diodes (16, 16′, 16″, . . . ) in dependence upon an image to be displayed by the display device.

2. An assembly as claimed in claim 1, characterized in that the control circuit (8) varies the intensities of the light emitted by the light-emitting diodes (16, 16′, 16″, . . . ) in response to the illumination level of the image to be displayed by the display device.

3. An assembly as claimed in claim 1 or 2, characterized in that the intensities of the light emitted by the light-emitting diodes (16, 16′, 16″, . . . ) can be adjusted on a frame-to-frame basis.

4. An assembly as claimed in claim 1 or 2, characterized in that the intensities of the light emitted by the light-emitting diodes (16, 16′, 16″, . . . ) can be adjusted for each color on a frame-to-frame basis.

5. An assembly as claimed in claim 1 or 2, characterized in that the light source comprises at least three light-emitting diodes (16, 16′, 16″, . . . ) having different light-emission wavelengths.

6. An illumination system as claimed in claim 1 or 2, characterized in that each of the light-emitting diodes (16, 16′, 16″, . . . ) comprises a luminous flux of at least 5 lm.

7. An illumination system as claimed in claim 6, characterized in that the light-emitting diodes (16, 16′, 16″, . . . ) are mounted on a printed circuit board.

8. A display device for use in an assembly as claimed in claim 1 or 2.

9. An illumination system for use in an assembly as claimed in claim 1 or 2.
